(19) United States
(12) Patent Application Publication
(10) Pub. No.: US 2020/0011455 A1
(43) Pub. Date: Jan. 9, 2020

(54) DUCT ASSEMBLY AND METHOD OF FORMING

(71) Applicant: Unison Industries, LLC, Jacksonville, FL (US)

(72) Inventors: Dattu GV Jonnalagadda, Ponnur (IN); Merin Sebastian, Karnataka (IN); Sagar Paramashivaiah, Karnataka (IN); Gordon Tajiri, Waynesville, OH (US); Emily Marie Phelps, Bellbrook, OH (US); Michael Ralph Storage, Beavercreek, OH (US)

(21) Appl. No.: 16/027,560

(22) Filed: Jul. 5, 2018

(51) Int. Cl. F16L 9/19

(52) U.S. Cl. CPC F16L 9/19

(57) ABSTRACT

Duct assembly and method of forming a duct assembly, the method including providing a duct having an outer surface and an inner surface, the outer surface defining a periphery and the inner surface defining a first fluid passageway, covering at least a portion of the outer surface with at least a portion of a sacrificial body, depositing a metal layer over an exposed surface of the sacrificial body, and removing the sacrificial body.

### BACKGROUND

Duct assemblies are used in a variety of stationary and mobile applications. For example, contemporary engines used in aircraft can include fluid passageways for providing flow from a fluid source to a fluid destination. In one non-limiting example, a bleed air system can receive pressurized bleed air from a compressor section of an engine and convey to a fluidly downstream component or system, such as an environmental control system. Additional fluid passageways can be utilized for carrying, transferring, or otherwise flowing fluid including, but not limited to, oil, coolant, water, fuel, or the like. In the example of an aircraft engine, the passageways can be exposed to high pressures, high temperatures, stresses, vibrations, thermal cycling, and the like. The passageway, or other component formed in a similar process, can be configured, designed, or arranged to provide reliable operation in the functional environment. The complexity and spacing requirements of the turbine engine often require particular ducting paths and structural attachments to the engine case in order to accommodate other engine components and maintain appropriate safety margins for the duct.

### BRIEF DESCRIPTION

In one aspect, the disclosure relates to a method of forming a duct assembly. The method includes providing a duct having an outer surface and an inner surface, the outer surface defining a periphery and the inner surface defining a first fluid passageway, covering at least a portion of the outer surface with at least a portion of a sacrificial body, depositing a metal layer over an exposed surface of the sacrificial body, and removing the sacrificial body to define at least one additional fluid passageway between the metal layer and the at least a portion of the outer surface.

In another aspect, the disclosure relates to a duct assembly. The duct assembly includes a first conduit having a first conduit wall defining a periphery and a first fluid passageway, and a second conduit wall unitarily formed with the first conduit wall, where the second conduit wall terminates on the first conduit wall, the second conduit wall in combination with the periphery of the first conduit wall defining a second fluid passageway, wherein a width is defined between the second conduit wall and the first conduit wall at a peripheral location on the periphery, and the width varies between a first peripheral location on the periphery and a second peripheral location on the periphery.

### BRIEF DESCRIPTION OF THE DRAWINGS

In the drawings:

FIG. 1 is a schematic cross-sectional view of a gas turbine engine with a duct assembly in accordance with various aspects described herein.

FIG. 2 is a perspective view of a duct and sacrificial body that can be utilized in the duct assembly of FIG. 1 according to various aspects described herein.

FIG. 3 illustrates perspective views of the duct and sacrificial body of FIG. 2 coupled to a flange according to various aspects described herein.

FIG. 4 is a sectional view of the duct and sacrificial body of FIG. 2 along line IV-IV.

FIG. 5 is a sectional view of the duct and sacrificial body of FIG. 5 with a metal layer according to various aspects described herein.

FIG. 6 is a sectional view of the duct assembly of FIG. 5 with an additional fluid passageway according to various aspects described herein.

FIG. 7 is a perspective view of the duct assembly of FIG. 6 coupled to a flange.

FIG. 8 illustrates sectional views of another duct assembly and sacrificial bodies according to various aspects described herein that can be utilized in the turbine engine of FIG. 1.

FIG. 9 illustrates sectional views of another duct assembly and sacrificial bodies according to various aspects described herein that can be utilized in the turbine engine of FIG. 1.

FIG. 10 illustrates sectional views of another duct assembly and sacrificial bodies according to various aspects described herein that can be utilized in the turbine engine of FIG. 1.

FIG. 11 illustrates sectional views of another duct assembly and sacrificial body according to various aspects described herein that can be utilized in the turbine engine of FIG. 1.

FIG. 12 is a schematic diagram of an electroforming bath for forming the duct assembly of FIG. 1.

FIG. 13 is a flow chart diagram demonstrating a method for forming the duct assembly of FIG. 1.

### DETAILED DESCRIPTION

Aspects of present disclosure are directed to a duct assembly, ducting, or conduit for providing flows of fluid. Such a duct assembly can be configured to provide fluid flows from various portion of an engine to one or more portions.

For purposes of illustration, the present disclosure will be described with respect to a gas turbine engine. Gas turbine engines have been used for land and nautical locomotion and power generation, but are most commonly used for aeronautical applications such as for airplanes, including helicopters. In airplanes, gas turbine engines are used for propulsion of the aircraft. It will be understood, however, that the disclosure is not so limited and can have general applicability in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine relative to the engine centerline. Additionally, as used herein, the terms “radial” or “radially” refer to a dimension extending between a center longitudinal axis of the engine and an outer engine circumference. Further, the terms “inlet” and “outlet” will refer to a fluid flow entry portion and exit portion, respectively. In an example where a fluid flow direction is changed, it can be appreciated that a former inlet can become an outlet, and vice versa.

In addition, as used herein, “a set” can include any number of the respectively described elements, including only one element.

All directional references (e.g., radial, axial, proximal, distal, upper, lower, upward, downward, left, right, lateral, front, back, top, bottom, above, below, vertical, horizontal, clockwise, counterclockwise, upstream, downstream, aft, etc.) are only used for identification purposes to aid the reader's understanding of the present disclosure, and do not create limitations, particularly as to the position, orientation, or use of the disclosure. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. In addition, as used herein, being “flush” with a given surface will refer to being level with, or tangential to, that surface.

Furthermore, “sacrificial” as used herein can refer to an element, component, or material composition that can be removed. Non-limiting examples of “sacrificial” elements can include a melt-able composition such as wax or plastic, a low melting temperature alloyed metal, or a dissolvable composition. In this sense, the “sacrificial” element can be removed by way of melting when exposed to a heating element, or dissolved when exposed to a dissolving agent. Additional or alternative non-limiting aspects of sacrificial element removal can be included, such as mechanical disassembly, or physically removing elements or sub-elements.

The exemplary drawings are for purposes of illustration only and the dimensions, positions, order, and relative sizes reflected in the drawings attached hereto can vary.

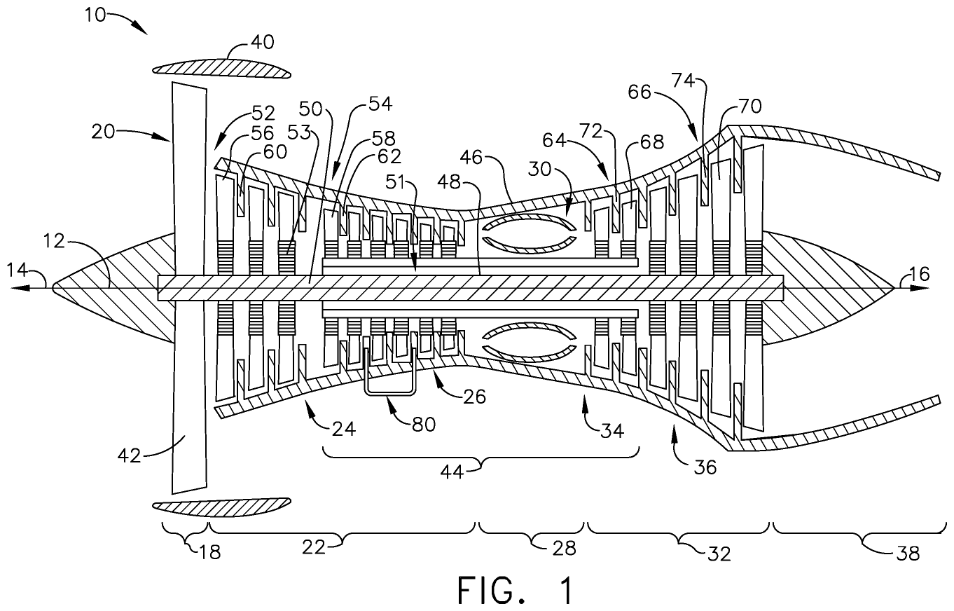

FIG. 1 is a schematic cross-sectional diagram of a gas turbine engine 10 for an aircraft. The engine 10 has a generally longitudinally extending axis or centerline 12 extending from forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a set of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The portions of the engine 10 mounted to and rotating with either or both of the spools 48, 50 are also referred to individually or collectively as a rotor 51.

The LP compressor 24 and the HP compressor 26 respectively include a set of compressor stages 52, 54, in which a set of compressor blades 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned downstream of and adjacent to the rotating blades 56, 58. It is noted that the number of blades, vanes, and compressor stages shown in FIG. 1 were selected for illustrative purposes only, and that other numbers are possible. The blades 56, 58 for a stage of the compressor can be mounted to a disk 53, which is mounted to the corresponding one of the HP and LP spools 48, 50, respectively, with stages having their own disks. The vanes 60, 62 are mounted to the core casing 46 in a circumferential arrangement about the rotor 51.

The HP turbine 34 and the LP turbine 36 respectively include a set of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

In operation, the rotating fan 20 supplies ambient air to the LP compressor 24, which then supplies pressurized ambient air to the HP compressor 26, which further pressurizes the ambient air. The pressurized air from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

Some of the air from the compressor section 22 can be bled off via one or more duct assemblies 80, and be used for cooling of portions, especially hot portions, such as the HP turbine 34, or used to generate power or run environmental systems of the aircraft such as the cabin cooling/heating system or the deicing system. In the context of a turbine engine, the hot portions of the engine are normally downstream of the combustor 30, especially the turbine section 32, with the HP turbine 34 being the hottest portion as it is directly downstream of the combustion section 28. Air that is drawn off the compressor and used for these purposes is known as bleed air.

Additionally, the ducts, or metal tubular elements thereof, can also be a fluid delivery system for routing a fluid through the engine 10, including through the duct assemblies 80. The duct assemblies 80, such as air duct or other ducting assemblies leading either internally to other portions of the turbine engine 10 or externally of the turbine engine 10, can also include one or more metal tubular elements or metallic tubular elements forming ducts or conduits configured to convey fluid from a first portion of the engine 10 to another portion of the engine 10. It is further contemplated that the duct assemblies 80 can form branches, such as a first branch being fluidly coupled to a second branch at an intersection, or multiple branches sharing a common intersection, a common inlet, or a common outlet, in non-limiting examples.

In addition, while the duct assemblies 80 are illustrated in the context of the turbine engine 10, it will be understood that the duct assemblies 80 can be configured for use in a variety of environments including a fuel manifold, an anti-ice inlet duct, an ejector system, a double walled system, scavenge tubes in an aircraft engine, bundle tubes in an aircraft engine, or drain tubes in an aircraft engine, in non-limiting examples.

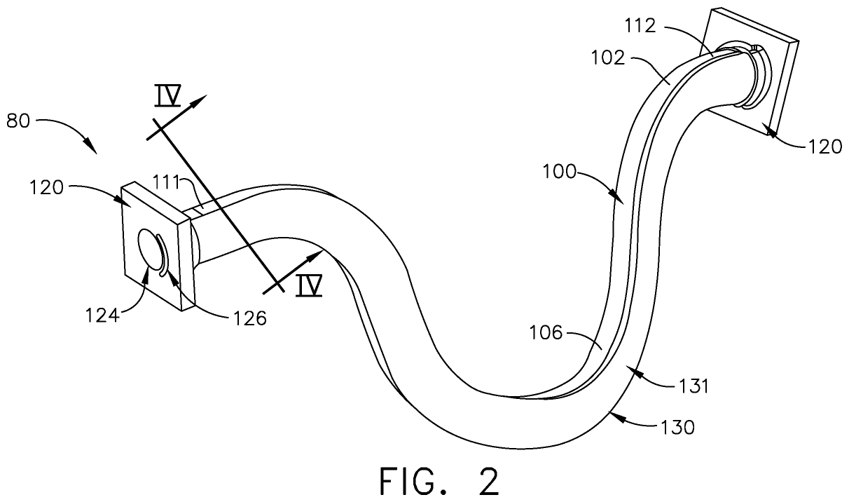

Turning to FIG. 2, a duct 100 is illustrated, it will be understood that the duct 100 is an exemplary duct that can form a portion of the duct assembly 80. The duct 100 is shown having an outer surface 102 defining a periphery 106 of the duct 100. It will be understood that the periphery can be any suitable shape, profile, or contour include irregular and need not be circular as shown in the attached figures. The duct 100 can be formed of any material suitable for the environment of the duct assembly 80, including metals such as aluminum or steel in non-limiting examples. The duct 100 can also be created or formed in any suitable manner including by cold drawing a metal tube, machining, roll forming, or additive manufacturing, in non-limiting examples.

The duct 100 can also have opposing first and second ends 111, 112. The first end 111 and the second end 112 can each be coupled to a flange 120. Each flange 120 can include a set of apertures to fluidly couple the duct 100 to other duct assemblies or in the illustrated example portions of the turbine engine 10. In the example shown, the flange 120 includes a first aperture 124 fluidly coupled to the first fluid passageway 110, as well as a second aperture 126 positioned adjacent to but spaced and separate from the first aperture 124. Either or both of the apertures 124, 126 can be coupled to other ducts or fluid supply conduits. In one example where the duct 100 is utilized for fuel delivery to an engine component, the flange 120 can fluidly couple the duct 100 to a fuel supply line (not shown).

In forming a duct assembly 80 configured to convey multiple fluid flows, a set 130 of sacrificial bodies 131 can be coupled to the duct 100 and coupled to the flange 120. In the illustrated example, a single sacrificial body has been illustrated. The sacrificial body 131 can be formed in any suitable manner including via additive manufacturing, blow molding, injection molding, in non-limiting examples. The sacrificial body 131 can include materials that can be removed or otherwise destroyed while the remainder of the duct assembly 80 remains intact. By way of non-limiting examples this can include plastics/polymers, wax, aluminum, or other low melting point metals. Furthermore, the sacrificial body 131 can be formed having any desired or predetermined size or geometry for forming any suitable shape, profile, or contour of a portion of the duct assembly 80 in combination with the duct 100.

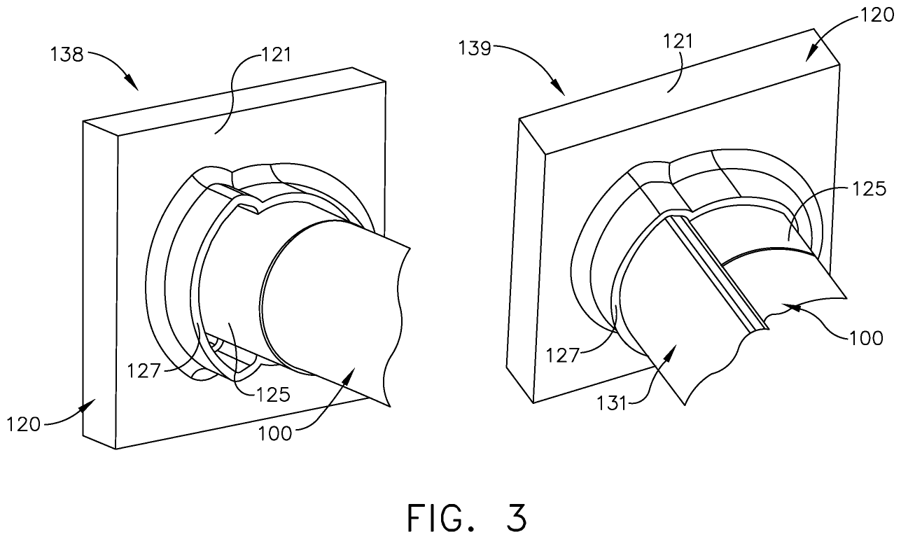

FIG. 3 further illustrates the flange 120 coupled to the first duct end 111. A first view 138 shows that the flange 120 can include a flange body 121 with a projection forming a cylindrical first seat 125 projecting from the flange body 121 and configured to receive the duct 100. In an example where the duct 100 is metallic, such as aluminum, it is contemplated that the duct 100 can be welded to the first seat 125. The first seat 125 can also be aligned with the first aperture 124 (FIG. 2). While illustrated as being cylindrical, it is contemplated that the first seat 125 can be formed with any suitable geometric profile for receiving the duct 100. In addition, the flange 120 can further include a second seat 127 projecting from the flange body 121 aligned with the second aperture 126 (FIG. 2). The second seat 127 is illustrated as at least partially surrounding the first seat 125, where the first seat 125 projects farther from the flange 120 than the second seat 127. The second seat 127 can also have a geometric profile suitable to receive and be coupled to the sacrificial body 131. While the first and second seats 125, 127 have been described as distinct elements, a single or unitary element can project from the flange and form a plurality of seats in a variety of arrangements as desired.

A second view 139 shows that the sacrificial body 131 can be received within the second seat 127 when coupled to the duct 100. For example, the sacrificial body 131 can be injection molded into the second seat 127, such that a portion of the sacrificial body 131 is formed within a portion of the flange 120. In another example, the sacrificial body 131 can be formed by injection molding, blow molding, or any other type of manufacturing process, and inserted into the second seat 127. It is further contemplated that the second seat 127 can be formed with any geometric profile, including a complementary geometric profile to that of the sacrificial body 131.

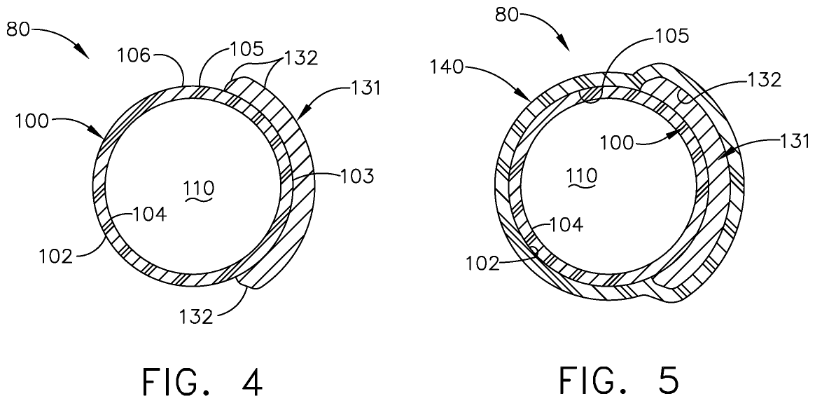

FIG. 4 illustrates a cross-section of a portion of the duct 100 and sacrificial body 131 of FIG. 2. The duct has been illustrated as having a circular cross-sectional geometric profile. It is contemplated that the duct 100 can have any desired geometric profile including square, square with rounded corners, oval or elliptical, or irregular. Furthermore, it can be appreciated that the duct 100 can be shaped to have different cross-sectional profiles along its length.

As shown, the duct 100 can further include an inner surface 104 defining a first fluid passageway 110. A portion 103 of the outer surface 102 of the duct 100 is covered with the sacrificial body 131. It is contemplated that the portion 103 can include any portion of the outer surface 102, up to and including the entire periphery 106. A remaining portion of the duct 100, not forming the portion 103, can include an outer exposed surface 105.

When assembled or otherwise placed adjacent the duct 100, the sacrificial body 131 can include an exposed surface 132. It will be understood that the exposed surface 132 need not surround the outer surface 102 of the duct 100.

FIG. 5 shows that a metal layer 140 can be deposited over the exposed surface 132 of the sacrificial body 131 and over at least some portion of the outer exposed surface 105 of the duct 100. It is contemplated that the metal layer 140 can be electroformed or electrodeposited over the exposed surface 132 and outer exposed surface 105. It is also contemplated that the metal layer 140 can include two or more metal layers. It will be understood that some part of the outer exposed surface 105 of the duct 100 can be shielded during the depositing of the metal layer 140.

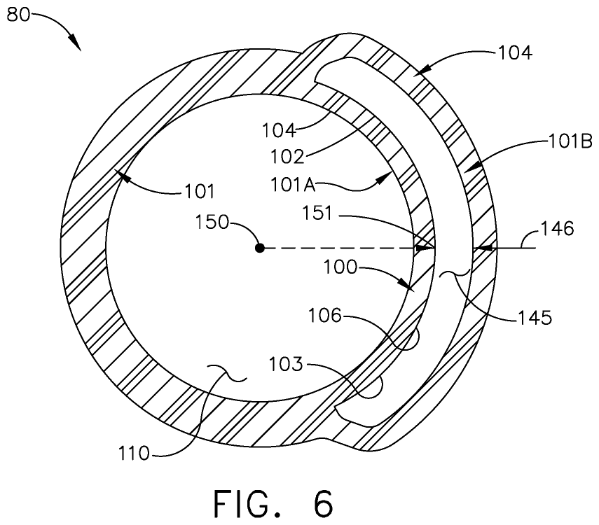

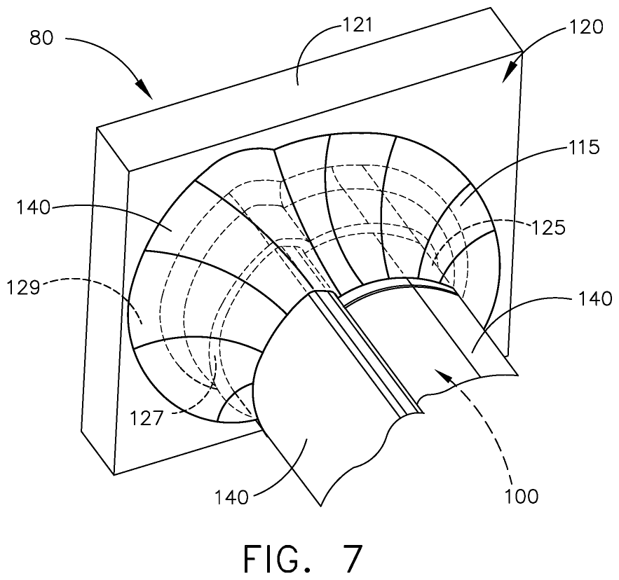

FIG. 6 illustrates the completed duct assembly 80 after removal of the sacrificial body 131 (FIG. 5). The removal can be performed in any suitable manner, non-limiting examples of which include by melting, such as through application of heat to the sacrificial body 131, by dissolving, e.g. a chemical dissolving process, or by softening, e.g. application of sufficient heat to soften the sacrificial body 131 for mechanical removal. The removal of the sacrificial body 131 can further define an additional fluid passageway 145 between the metal layer 140 and the portion 103 of the outer surface 102 of the duct 100. The additional fluid passageway 145 is fluidly isolated from the first fluid passageway 110. The additional fluid passageway 145 can also be fluidly coupled to the second aperture 126 of the flange 120 (FIG. 2).

In the completed duct assembly 80, the duct 100 can further define a first conduit 101 with a first conduit wall or first conduit wall section 101A defined between the outer surface 102 and the inner surface 104. The first conduit wall section 101A can define the periphery 106 as well as the first fluid passageway 110 as shown. The metal layer 140 in conjunction with a portion of the duct 100 can define a second conduit wall or second conduit wall section 101B. It will be understood that while the walls or wall sections have been identified with different numerals this is by way of designation for clarity and that the walls or wall sections can be unitarily formed with the first conduit wall 101A. The second conduit wall 101B can terminate on the first conduit wall 101A. In addition, the second conduit wall 101B in combination with the periphery 106 of the first conduit wall 101A defines the additional fluid passageway 145.

A width 146 of the additional fluid passageway 145 can be defined between the second conduit wall 101B and the first conduit wall 101A at a first peripheral location 151 on the periphery 106. As used herein, “peripheral location” will refer to a location on the periphery with respect to a midpoint 150 of the first fluid passageway 110. In the illustrated example the peripheral location is located on a circular periphery. In other examples, peripheral locations can be located about a square periphery (e.g. at a corner of the square), or about an irregular or asymmetric periphery, where the midpoint would be positioned at a geometric center of the irregular periphery. Further, the width 146 of the additional fluid passageway 145 can vary or be constant between two peripheral locations as desired.

FIG. 7 illustrates the completed duct assembly 80 including the flange 120. It is further contemplated that the metal layer 140 can also be deposited over at least a portion 129 of the flange 120. As shown, the metal layer 140 covers over the first and second seats 125, 127 (FIG. 3).

It is also contemplated that the metal layer 140 can include at least one transitional surface 115, illustrated as forming a smooth transition to the flange body 121. As used herein, “smooth transition” will refer to a layer thickness decreasing toward zero in a direction toward a distal edge of the structure. It will be understood that the use of a straight-edge interface between components can, in some instances, result in a higher current density during the electroforming process, producing a greater electroformed metal layer thickness area proximate to that edge. Thus, aspects of the disclosure can be included wherein component edges can be configured, selected, or the like, to include beveled, blended, or radial edges configured or selected to ensure a uniform expected electroformed metal layer. The transitional surface or smooth transition can also be referred to in the art as a knife edge. The tapering of the body allows the flange 120 to more seamlessly be formed with the metal layer 140 in order to smoothly direct stresses between components. This makes the final part more durable as a result.

In operation, the flange 120 can be fluidly coupled to at least one other fluid conduit to convey fluid through the duct assembly 80. In a non-limiting example, the first aperture 124 of the flange 120 can be coupled to a coolant supply conduit while the second aperture 126 is coupled to a fuel supply conduit. In this manner the single duct assembly 80 can supply multiple types of fluid through multiple fluidly separated conduits, e.g. supplying coolant via the first fluid passageway 110 and fuel via the additional fluid passageway 145. It is further contemplated that the first fluid passageway 110 can be thermally isolated from the additional fluid passageway 145, where fluids having differing temperatures can be supplied by the duct assembly 80. In such a case, the duct 100 can be made from an insulating material including thermoplastic or fiberglass, such that the first conduit wall 101A does not conduct heat between the fluid passageways 110, 145. Alternately the fluid passageways 110, 145 can be thermally coupled, including by way of a metallic duct 100 forming a thermally conductive first conduit wall 101A therebetween.

It should be appreciated that the duct assembly 80 as shown represents only a portion of the duct, and the duct assembly 80 including the electroformed portions and the duct 100 can be shorter or longer, or include more or different profiles, thicknesses, turns, or cross-sectional areas as desired.

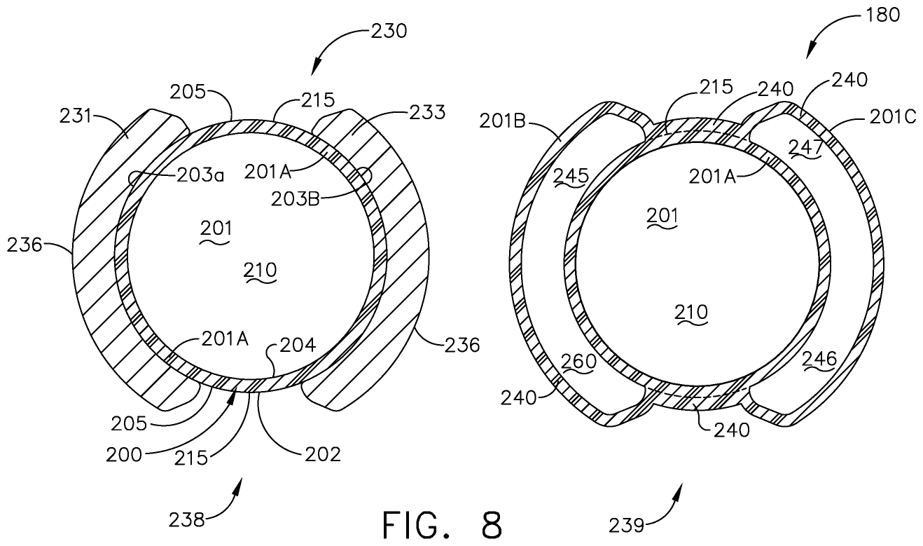

Turning to FIG. 8, another duct assembly 180 is illustrated that can be utilized in the engine 10. The duct assembly 180 is similar to the duct assembly 80; therefore, like parts will be identified with like numerals increased by 100, with it being understood that the description of the like parts of the duct assembly 80 applies to the duct assembly 180, except where noted.

A first view 238 illustrates a duct 200 and set of sacrificial bodies 230. The duct 200 includes an outer surface 202 and an inner surface 204. The duct 200 also includes a first conduit 201 defining a first fluid passageway 210 with a first conduit wall 201A defined between the outer and inner surfaces 202, 204.

A first portion 203A of the duct outer surface 202 can be covered with a first sacrificial body 231. A second portion 203B of the outer surface 202, different from the first portion 203A, can be covered with a second sacrificial body 232. The first and second sacrificial bodies 231, 232 can be identical, symmetric, asymmetric, complementary, or having differing geometric profiles as desired.

A second view 239 shows the completed duct assembly 180 after depositing a metal layer 240 and removing the first and second sacrificial bodies 231, 232. With reference to the first and second views 238, 239, the metal layer 240 can be deposited over an outer exposed surface 205 of the duct 200 as well as a first exposed surface 235 of the first sacrificial body 231 and a second exposed surface 236 of the second sacrificial body 232 as shown.

Removal of the set 230 of sacrificial bodies can define a plurality of secondary conduits 260 as shown in the second view 239. In the illustrated example, removing the first sacrificial body 231 defines a first additional fluid passageway 245, and removing the second sacrificial body 232 defines a second additional fluid passageway 247. Each of the additional fluid passageways 245, 247 are radially offset from the first fluid passageway 210. In addition, the first and second additional fluid passageways 245, 247 can have corresponding first and second additional conduit walls 201B, 201C unitarily formed with the first conduit wall 201A. The additional conduit walls 201B, 201C (e.g. secondary conduit walls formed by the metal layer 240) thus define a plurality of secondary fluid passageways (e.g. the first and second additional fluid passageways 245, 247) that correspond with the secondary conduits 260. In this manner, the plurality of secondary fluid passageways are fluidly separated from the first fluid passageway 210 by the first conduit wall 201A.

In the illustrated example, the first and second portions 203A, 203B of the outer surface 202 covered by the sacrificial bodies 231, 233 are spaced from one another. In such a case, transitional surfaces 215 as described above can be located between the first portion 203A and the second portion 203B. It can be appreciated that depositing the metal layer 240 can include forming the metal layer 240 over the transitional surface 215. While not illustrated, it is further contemplated that the transitional surface 215 can be shielded during formation of the metal layer 240 such that the metal layer 240 includes two metal layers, each covering a corresponding sacrificial body 231, 233.

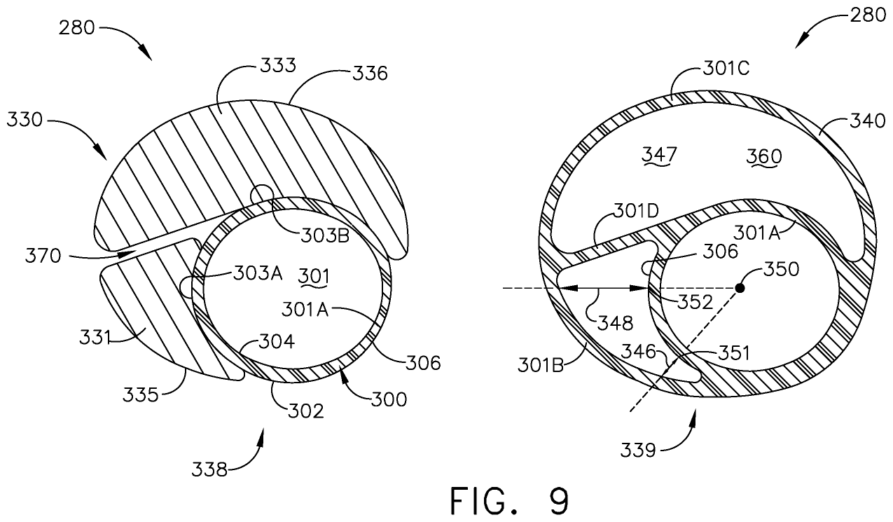

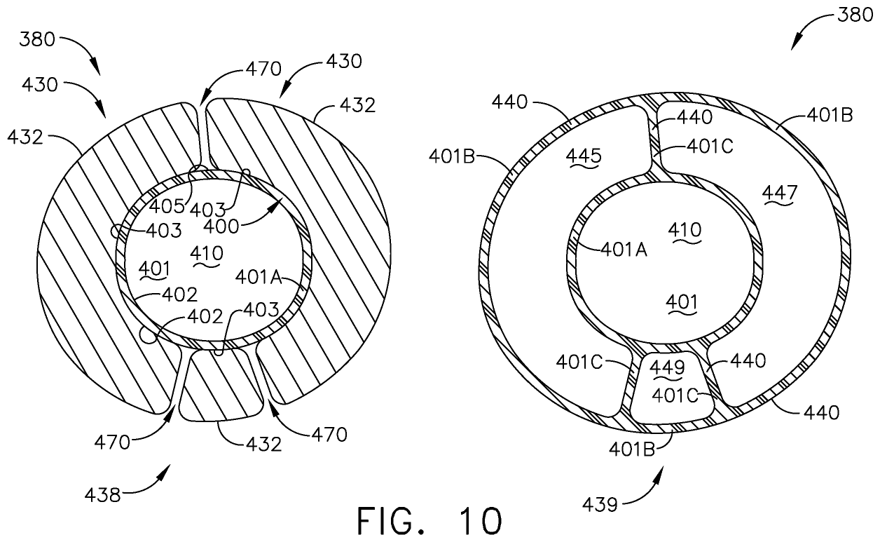

Turning to FIG. 9, another duct assembly 280 is illustrated that can be utilized in the engine 10. The duct assembly 280 is similar to the duct assembly 80; therefore, like parts will be identified with like numerals increased by 200, with it being understood that the description of the like parts of the duct assembly 80 applies to the duct assembly 280, except where noted.

A first view 338 illustrates a duct 300 and set of sacrificial bodies 330. The duct 300 includes an outer surface 302 and an inner surface 304. The duct 300 further includes a first conduit 301 defining a first fluid passageway 310 with a first conduit wall 301A defined between the outer and inner surfaces 302, 304.

A first sacrificial body 331 is positioned to cover a first portion 303A of the duct outer surface 302, and a second sacrificial body 333 covers a second portion 303B of the outer surface 302. One difference is that a gap 370 is defined between the first and second sacrificial bodies as shown.

A second view 339 illustrates the completed duct assembly 380 after depositing a metal layer 340 over first and second exposed surfaces 335, 336 of the respective sacrificial bodies 331, 333, as well as over an outer exposed surface 305 of the duct 300, where the sacrificial bodies 331, 333 have been removed. The metal layer forms a first additional conduit wall 301B and a second additional conduit wall 301C as shown. It is also contemplated that the metal layer 340 fills the gap 370. The metal layer 340 within the gap 370 forms a third additional conduit wall 301C fluidly separating a first additional fluid passageway 345 from a second additional fluid passageway 357.

First and second peripheral locations 351, 352 on a periphery 306 of the duct 300 are also shown in the second view 339. One difference is that a first width 346 is defined between the second additional conduit wall 301B and the first conduit wall 301A at a first peripheral location 351. A second width 348 is defined between the conduit walls 301B, 301A at a second peripheral location 352. One difference is that the first width 346 is smaller than the second width 348. In addition, it is contemplated that a width between the conduit walls 301B, 301A can continuously increase between the first and second peripheral locations 351, 352 as shown.

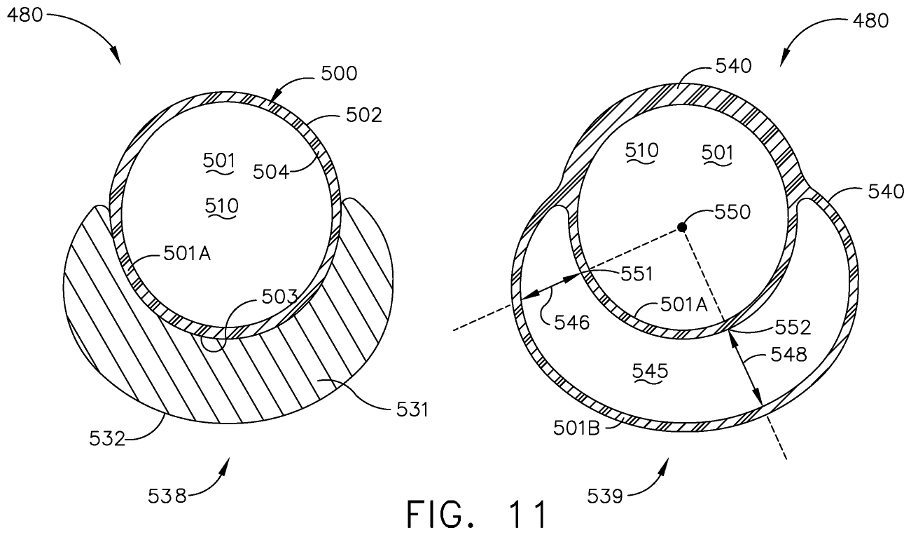

Turning to FIG. 10, another duct assembly 380 is illustrated that can be utilized in the engine 10. The duct assembly 380 is similar to the duct assembly 80; therefore, like parts will be identified with like numerals increased by 300, with it being understood that the description of the like parts of the duct assembly 80 applies to the duct assembly 380, except where noted.

A first view 438 illustrates a duct 400 and sacrificial body 430. The duct 400 includes an outer surface 402 and an inner surface 404. The duct 400 further includes a first conduit 401 defining a first fluid passageway 410 with a first conduit wall 401A defined between the outer and inner surfaces 402, 404. A set of sacrificial bodies 430 are provided to cover portions 403 of the duct outer surface 402 with gaps 470 formed between adjacent sacrificial bodies 430.

A second view 439 illustrates the duct assembly 380 after depositing a metal layer 440 over exposed surfaces 432 of the set of sacrificial bodies 430 and over outer exposed surfaces 405 of the duct 400. Removal of the set of sacrificial bodies 430 defines a plurality of secondary conduits with a corresponding set of additional fluid passageways, illustrated as first, second, and third additional fluid passageways 445, 447, 449.

One difference is that the set of additional fluid passageways encases the outer surface 402 of the duct 400. More specifically, the metal layer 440 forms additional conduit walls 401B spaced from the first conduit wall 401A, as well as forming second additional conduit walls 401C within the gaps 470 that fluidly separate the additional fluid passageways 445, 447, 449.

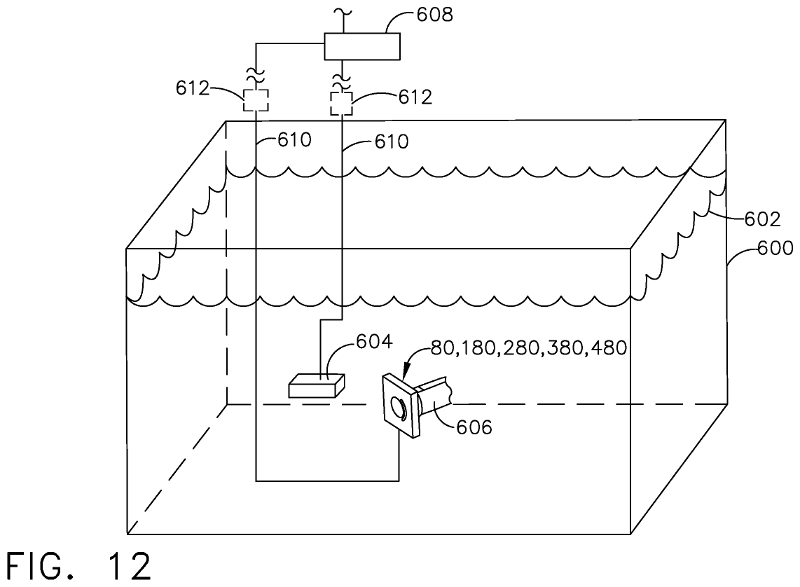

Turning to FIG. 11, another duct assembly 480 is illustrated that can be utilized in the engine 10. The duct assembly 480 is similar to the duct assembly 80; therefore, like parts will be identified with like numerals increased by 400, with it being understood that the description of the like parts of the duct assembly 80 applies to the duct assembly 480, except where noted.

A first view 538 of the duct assembly 480 shows a duct 500 with an outer surface 502 and an inner surface 504. The duct 500 includes a first conduit 501 defining a first fluid passageway 510 with a first conduit wall 501A defined between the outer and inner surfaces 502, 504. A sacrificial body 531 is provided to cover a portion 503 of the duct outer surface 502.

A second view 539 illustrates the duct assembly 480 after depositing a metal layer 540 over an exposed surface 532 of the sacrificial body 531 and over an outer exposed surface 505 of the duct 500. Removal of the sacrificial body 531 defines a second additional fluid passageway 545 with a second conduit wall 501B spaced from the first conduit wall 501A.

A first width 546 is defined between the conduit walls 501A, 501B at a first peripheral location 546, and a second width 548 is defined at a second peripheral location 548. One difference is that the width continuously varies between adjacent peripheral locations, including continuously increasing or continuously decreasing.

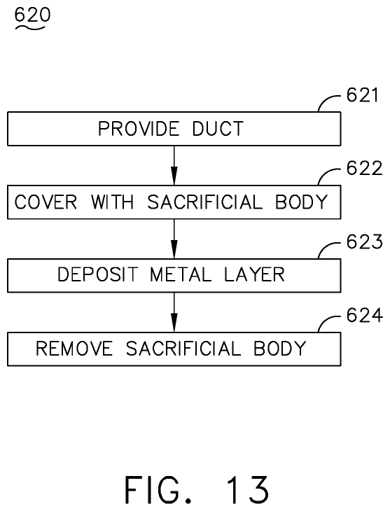

The electroforming process is illustrated by way of an electrodeposition bath in FIG. 12. As used herein, “electroforming” or “electrodeposition” can include any process for building, forming, growing, or otherwise creating a metal layer over another substrate or base. Non-limiting examples of electrodeposition can include electroforming, electroless forming, electroplating, or a combination thereof. While the remainder of the disclosure is directed to electroforming, any and all electrodeposition processes are equally applicable. In one non-limiting example of an electroforming process, the duct and sacrificial body can be submerged in an electrolytic liquid and electrically charged. The electric charge of the duct and sacrificial body can attract an oppositely charged electroforming material through the electrolytic solution. The attraction of the anodic material to the exposed surface of the sacrificial body and outer exposed surface of the duct ultimately deposits the electroforming material on the exposed surfaces creating the metal layer unitarily with the duct to form the duct assembly.

In non-limiting examples, electroforming material can include nickel and nickel alloys, iron and iron alloys, or the like, or a combination thereof. In another non-limiting example, at least a portion of the respective exposed surfaces of the duct and sacrificial body can include a metallized layer prior to the electroforming process.

In the illustrated example, an exemplary bath tank 600 carries a single metal constituent solution 602. The single metal constituent solution 602, in one non-limiting example, can include nickel alloy carrying alloying metal ions. An anode 604 spaced from a cathode 606 is provided in the bath tank 600. The anodes 604 can be sacrificial anodes or an inert anode. While one anode 604 is shown, it should be understood that the bath tank 600 can include any number of anodes as desired. The duct assembly 80, 180, 280, 380, 480 including the duct 100, 200, 300, 400, 500, flange 120, and sets of sacrificial bodies 130, 231, 330, 430, 530 can form the cathode 606 having electrically conductive material. It is also contemplated that a conductive spray or similar treatment can be provided to the duct assembly 80, 180, 280, 380, 480 to facilitate formation of the cathode 606. In addition, while illustrated as one cathode 606, it should be appreciated that one or more cathodes are contemplated for use in the bath tank 600.

A controller 608, which can include a power supply, can electrically couple to the anode 604 and the cathode 606 by electrical conduits 610 to form a circuit via the conductive metal constituent solution 602. Optionally, a switch 612 or sub-controller can be included along the electrical conduits 610 between the controller 608, anode 604, and cathode 606. During operation, a current can be supplied from the anode 604 to the cathode 606 to electroform a monolithic body at the duct assembly 80, 180, 280, 380, 480. During supply of the current, nickel or nickel alloy from the single metal constituent solution 602 form a metallic layer, such as the metal layers described above to form a duct assembly having a preform that includes a unitary monolithic body. The process described allows for electroforming sections with thicker material by using the preform bodies, this in turn places material in the areas with the highest stress allowing for optimized weight control. The preform bodies can expedite the electroforming process allowing less time in the bath tank to achieve the desired thicknesses. Faster runs in the bath tank in turn result in lower cost. Stress risers associated with attachment hardware, mounting holes, or rivets in sheet metal doublers would be eliminated.

FIG. 13 illustrates a flow chart demonstrating a method 620 of forming a duct assembly, such as the duct assembly 80, 180, 280, 380, 480 described above. The method 620 begins at 621 with providing a duct, such as the duct 100, 200, 300, 400, 500 having an outer surface and an inner surface (e.g. the surfaces 102, 104), where the outer surface defines a periphery (e.g. the periphery 106) and the inner surface defines a first fluid passageway (e.g. the passageway 110). At 622 at least a portion of the outer surface (e.g. the portion 103), can be covered with at least a portion of a sacrificial body such as the sacrificial body 131. At 623 a metal layer, such as the metal layer 140, can be deposited over an exposed surface of the sacrificial body. Optionally, the metal layer can be deposited over a transitional surface between portions of the duct covered by sacrificial bodies. In another example, the metal layer can include two or more separate metal layers covering the sacrificial bodies, where the metal layer does not cover the transitional surface.

At 624 the sacrificial body can be removed to define at least one additional fluid passageway between the metal layer and at least a portion of the outer surface. Optionally, the removal of the sacrificial bodies after can define a set of additional fluid passageways each adjacent to one another, such as by filling a gap between sacrificial bodies with the metal layer (FIGS. 9-10).

Many other possible embodiments and configurations in addition to that shown in the above figures are contemplated by the present disclosure. One advantage that can be realized is that the above described aspects provide for a hybrid fluid delivery system with unitary multiple-conduit duct assemblies in place of traditional bundles of individual conduits coupled together. Such a unitary duct assembly can eliminate welding and machining operations with low maintenance and repair. Handling and assembly issues can also be eliminated, as well as additional hardware such as clamps utilized in traditionally-bundled conduits. In addition, the use of electroforming provides for increased stiffness to meet structural designs as well as simplifying the manufacture of duct assemblies compared with traditional methods of forming ducts. Further, the surface finish achieved by electroforming, including the use of transitional surfaces between components, provides structural integrity for desired fluid pressure drops within the duct assembly. Complex routing, non-circular features, and variable-thickness portions at critical stress zones can be manufactured using the proposed manufacturing process.

Yet another advantage of the above described aspects is by utilizing the electrodeposited processes described, a minimal thickness of the metal layer for component integrity is predictable during forming, further ensuring conduit integrity without adding unnecessary mass, or bulk. When designing aircraft components, important factors to address are size, weight, and reliability. The above described electrodeposited fluid conduit with preform body results in a lower weight, smaller sized, increased performance, and increased integrity system. Reduced weight and size correlate to competitive advantages during flight.

To the extent not already described, the different features and structures of the various embodiments can be used in combination with each other as desired. That one feature cannot be illustrated in all of the embodiments is not meant to be construed that it cannot be, but is done for brevity of description. Thus, the various features of the different embodiments can be mixed and matched as desired to form new embodiments, whether or not the new embodiments are expressly described. Combinations or permutations of features described herein are covered by this disclosure. It will be understood that while the walls or wall sections have been identified with different numerals this is by way of designation for clarity and that the walls or wall sections can be unitarily formed.

This written description uses examples to disclose the invention, including the best mode, and also to enable any person skilled in the art to practice the invention, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of forming a duct assembly, the method comprising:
providing a duct having an outer surface and an inner surface, the outer surface defining a periphery and the inner surface defining a first fluid passageway;
covering at least a portion of the outer surface with at least a portion of a sacrificial body;
depositing a metal layer over exposed surface of the sacrificial body; and
removing the sacrificial body to define at least one additional fluid passageway between the metal layer and the at least a portion of the outer surface.

2. The method of claim 1 wherein the depositing further comprises depositing the metal layer over a second exposed surface of the duct.

3. The method of claim 1 wherein the depositing the metal layer further comprises electroforming the metal layer.

4. The method of claim 1 wherein providing the duct further comprises forming the duct.

5. The method of claim 4 wherein the forming the duct further comprises drawing a metal tube to form the duct.

6. The method of claim 4 wherein forming the duct further comprises coupling an end of the duct to a flange.

7. The method of claim 6 further comprising covering at least a portion of the flange with another portion of the sacrificial body.

8. The method of claim 7 wherein the covering the at least a portion of the flange comprises injection molding a sacrificial material into a seat on the flange.

9. The method of claim 7 wherein the depositing further comprises depositing the metal layer over a portion of the flange.

10. The method of claim 1 wherein the covering further comprises covering a first portion of the outer surface with a first sacrificial body and covering a second portion of the outer surface, different from the first portion, with a second sacrificial body.

11. The method of claim 10 wherein the depositing further comprises depositing a metal layer over at least the first exposed surface of the first sacrificial body and an other exposed surface of the second sacrificial body.

12. The method of claim 11 wherein the first portion and the second portion are spaced and a transitional surface is located between the first portion and the second portion, and wherein the depositing further comprises forming a metal layer over the transitional surface.

13. The method of claim 10 wherein the removing further comprises removing the first sacrificial body to define a first additional fluid passageway and removing the second sacrificial body to define a second additional fluid passageway.

14. The method of claim 1 wherein the removing further comprises removing a set of sacrificial bodies to define a set of additional fluid passageways each adjacent to one another.

15. The method of claim 14 wherein the set of additional fluid passageways encases the outer surface of the duct.

16. A duct assembly, comprising:
a first conduit having a first conduit wall defining a periphery and a first fluid passageway; and
a second conduit wall unitarily formed with the first conduit wall, where the second conduit wall terminates on the first conduit wall, the second conduit wall in combination with the periphery of the first conduit wall defining a second fluid passageway;
wherein a width is defined between the second conduit wall and the first conduit wall at a peripheral location on the periphery, and the width varies between a first peripheral location on the periphery and a second peripheral location on the periphery.

17. The duct assembly of claim 16 wherein a first width is defined between the second conduit wall and the first conduit wall at a first peripheral location, and a second width is defined between the second conduit wall and the first conduit wall at a second peripheral location, the first width being smaller than the second width.

18. The duct assembly of claim 16 wherein the width increases between the first peripheral location and the second peripheral location.

19. The duct assembly of claim 16 wherein the duct assembly is configured for use in a fuel manifold, an anti-ice inlet duct, an ejector system, a double walled system, scavenge tubes in an aircraft engine, bundle tubes in an aircraft engine, or drain tubes in an aircraft engine.

20. The duct assembly of claim 16 wherein a first width is defined between the second conduit wall and the first conduit wall at a first peripheral location, a second width is defined between the second conduit wall and the first conduit wall at a second peripheral location, and a third width is defined between the second conduit wall and the first conduit wall at a third peripheral location, and wherein the first width is equal to the third width and smaller than the second width.
